(19) United States
(12) Patent Application Publication
(10) Pub. No.: US 2010/0290962 A1
(43) Pub. Date: Nov. 18, 2010

(54) FUNCTIONALISED MATERIALS AND USES THEREOF

(75) Inventors: John Robert Howe Wilson, Oxford (GB); Nico Galaffu, Oxford (GB); Siud Pui Man, Oxford (GB); Robin Wilkes, Oxford (GB)

Correspondence Address: LAHIVE & COCKFIELD, LLP;FLOOR 30, SUITE 3000, ONE POST OFFICE SQUARE, BOSTON, MA, 02109, US

(73) Assignee: PHOSPHONICS LTD, Oxford (GB)

(21) Appl. No.: 12/738,743

(22) PCT Filed: Oct. 20, 2008
(86) PCT No.: PCT/EP08/08867

§ 371 Date: Jul. 30, 2010

(30) Foreign Application Priority Data
Oct. 20, 2007 (GB) 0720579.2

(51) Int. Cl. C22B 11/00; B01J 41/12; C02F 1/42; C22B 23/00

(52) U.S. Cl. 423/22; 521/25; 210/681; 423/139

(57) ABSTRACT

[(O_{3/2})SiCH₂CH₂SX]ₐ[Si(O_{4/2})]_{b}[WSi(O_{3/2})]_{c}[VSi(O_{3/2})]_{d} wherein X is selected from (CR¹R²)ₑNR⁵CO NHR, (CR¹R²)ₑNR⁵CSNHR, W when present is selected from (CR⁶R⁷)ₑZR, (CH₂)₃SR1(CH₂)₃NRR¹, (CH₂)ₑSR⁸, CH₂CH₂S (CR¹R²)_{f}NR⁵CONHR, CH₂CH₂S(CR¹R²),NR⁵CSNHR, CH₂CH₂S(CH₂)_{f}OR; Z is O or S, R, R¹⁻⁷ are independently selected from hydrogen, alkyl group, aryl group or alkylaryl group, R⁸ is selected from [CH₂CH₂NR¹]_{P}R and (CR¹R²)ₘSR⁹ where R⁹ is hydrogen, C₁₋₂₂-alkyl group, and V is a group which is optionally substituted and selected from a C₁₋₂₂-alkyl group, C₂₋₂₂-alkenyl group, a C₂₋₂₂-alkynyl group or an aryl group. The compounds are useful as immobilisation materials for bio-molecules including enzymes, cation and anion exchangers, organic and inorganic compound scavengers, solid phase purification or extraction materials, removal and purification of biological compounds including endotoxins, anti-microbial agents, hydrophilicity modifiers, flame proofing agents, antistatic agents, coatings for biomedical devices, water repellent films and coatings, solid phase synthesis materials and chromatography materials.

The invention relates to new functionalised materials and their uses. The materials of the invention may be used in a wide range of applications for example as immobilisation materials for bio-molecules including enzymes, cation and anion exchangers, organic and inorganic compound scavengers, solid phase purification or extraction materials, removal and purification of biological compounds including endotoxins, precious metal recovery, anti-microbial agents, hydrophilicity modifiers, flame proofing agents, antistatic agents, coatings for biomedical devices, water repellent films and coatings, solid phase synthesis materials and chromatography materials. The invention also relates to precursors of these new products and processes for their production.

The use of functionalised solids is growing rapidly for many different applications such as solution phase synthesis, solid phase synthesis, solid phase extraction, catalysis, catalyst supports, product purification and the immobilisation and use of bio-molecules such as enzymes for manufacture. The chemical structure of the functional group or combination of functional groups as well as the chemical nature and length of the chain or combination of chains that attach the functionality to the solid support is important in determining the performance characteristics. Thus performance for particular applications is dependent on chemical structure and the arrangement of the functionality near to the surface. In these applications the operational advantages of functionalised solids are ease of manipulation, simple separation from the rest of the medium by filtration and regeneration and reuse. Key requirements for the operation of these functionalised solids are excellent physical and chemical stability over a wide range of operating conditions, broad solvent applicability, fast kinetics—fast and easy access to the functional groups and functional groups with high intrinsic activity for the desired application. In addition the preparation of these functionalised materials has to be simple from readily available reagents. Finally it is highly advantageous if the functional groups can be readily transformed into different functionalised materials that can be used for other applications.

Precious metals including platinum, rhodium, palladium, ruthenium, iridium, rhenium and gold are widely used in a diverse range of applications. A key commercial and operational requirement is the capture of these metals for reuse given their cost and limited availability and their removal from process streams to ensure product purity. New and better technologies are required in order to capture as much as possible of these precious metals from product and waste streams.

As a consequence of stricter environmental regulations there is a growing requirement for more effective systems for the removal and recovery of toxic and hazardous chemicals from many sources including a wide spectrum of contaminated products, active pharmaceutical ingredients (API), solvents, potable water and aqueous based wastes and from contaminated waters. For example in the pharmaceutical industry metal catalysts are increasing being used in the manufacture of APIs or their intermediates. Given the toxicity of these metals very low residual levels have to be achieved in the API. In the preparation of compound libraries for biological evaluation simple and quick processes are required to purify reaction mixtures in order to screen thousands of compounds to identify leads for optimisation and development programmes. The electronics industry has a particular need for ultra pure water with very low levels of both cations and anions. Other industries such as the nuclear industry and the electroplating industry generate substantial quantities of water-based effluent that are heavily contaminated with undesirable metal ions.

Functionalised solid materials are used in solution phase organic synthesis to aid rapid purification and workup. These materials, also known as scavengers, may remove excess reagents and side products. Typically, a scavenger is added to a solution to quench and selectively react with excess or unreacted reagents and reaction side products. The unwanted chemicals now attached to the functionalised materials are removed by simple filtration. This simple process circumvents the standard purification methodologies of liquid-liquid extraction, chromatography and crystallisation.

Genotoxic agents are capable of causing direct or indirect damage to DNA. Genotoxic impurity assessments are required for new and existing pharmaceutical agents. Standard impurity thresholds are not applicable to genotoxic impurities. Several pharmaceutical agents have been put on clinical hold due to potential genotoxic impurities, and in some cases products have been recalled. By their nature, potential genotoxic impurities are usually highly reactive and analysis down to the required limits is challenging. One class of genotoxic impurities are alkylating agents. The syntheses to make pharmaceutical agents are now being reviewed to identify potential genotoxic impurities and their fate. Possible solutions to remove such genotoxic agents include re-crystallisation or scavenging either the potential genotoxic impurity or its precursors. Thus there is the need to design effective heterogeneous scavengers for such genotoxic impurities.

Due to their toxicity there is a growing requirement for more effective systems for the removal and recovery of cations and anions including a wide spectrum of contaminated products, active pharmaceutical ingredients (API), solvents, potable water and aqueous based wastes and from contaminated waters. Substituted polystyrene derivatives are known for use as scavengers for such applications but they have a number of limitations such as lack of thermal stability, swelling and shrinking in organic solvents and a limited range of functional groups as well as poor selectivity.

Precious metal mediated reactions enable the organic chemist to conduct a wide range of reactions used in the manufacture of products for a number of industries. Typical reactions include Suzuki, Heck, oxidations and reductions and metals and their complexes such as platinum, palladium and rhodium are extensively used. A major problem encountered with the use of these systems is the significant loss of these expensive and highly toxic metals. Furthermore in the production of active pharmaceutical agents (APIs) using such metal mediated reactions, it is found that the metal invariably complexes to the desired API and residual metal contents in the range of 600-1000 ppm are not uncommon. The current target for palladium, platinum, rhodium and nickel is less than 5 ppm. Various methods have been tried to reduce the residual palladium content, most unsuccessfully. Selective re-crystallisation leads to only a slight lowering of metal content. A lower yield of the API is a significant unwanted side effect of this process. Attempts to reposition the precious metal catalysed reaction from the final to an earlier step leads also to a slight but not significant lowering of metal content. Attempts to pass a solution of the API through a medium containing a metal exchanger such as a functionalised polystyrene resin have also been largely unsuccessful. Alternative and more costly processes have been tried—washing with an aqueous solution of a suitable metal chelator. A number of such reagents have been used with only limited success. Thus there is a need to design new functionalised materials that have very high affinity for precious metals and can readily remove them from tightly bound complexes. Furthermore given the structural diversity of APIs it is necessary to have a range of functionalised materials with different structures and high affinity in order to provide an effective solution.

There are many advantages of immobilising biological molecules such as enzymes, polypeptides, proteins and nucleic acids. These include their separation and purification. To be effective the functionality on the insoluble support has to be closely designed to match the spatial arrangement and the hydrophobic-hydrophilic structural features of the biological compound.

Highly toxic biological compounds such as endotoxins need to be removed from all sorts of aquatic environments as well as from water used in medical and pharmaceutical applications.

Specific binding to a functional group on an insoluble support would enable separation from a mixture or an aqueous stream.

Immobilising biocatalysts possess many operational and performance advantages over the homogeneous enzyme. These include ease of separation of biocatalyst from the reaction mixture, reuse of biocatalyst, better stability of the biocatalyst particularly towards organic solvents and heat, use of fixed bed reactors and lower production costs. Immobilisation of enzymes has primarily been achieved through physical coating of biological, inorganic or organic frameworks. Here the enzyme is physical adsorbed onto the surface. However the extent of leaching from the framework ranges from very high to low and is dependent on the nature of the operating conditions particularly solvent. A covalent attachment between the enzyme and the framework would provide a solution to this problem. Such covalent attachment is known but invariably leads to significant deactivation of the enzyme.

The inventors have discovered a class of compounds which have a desirable combination of characteristics and make them suitable for use in a range of applications including immobilisation materials for bio-molecules including enzymes, acting as scavengers for inorganic and organic compounds, solid phase purification or extraction materials, removal and purification of biological compounds including endotoxins, ion exchange materials, catalysts, catalyst immobilisation supports, anti-microbial agents, hydrophilicity modifiers, flame proofing agents, antistatic agents, solid phase synthesis materials and chromatography materials, or which are precursors for these.

In a first aspect of the present invention, there is provided a compound of General Formula 1:

[(O_{3/2})SiCH₂CH₂SX]ₐ[Si(O_{4/2})]_{b}[WSi(O_{3/2})]_{c}[VSi(O_{3/2})]_{d}

wherein X is selected from
H
(CR¹R²)ₑNR⁵CONHR
(CR¹R²)ₑNR⁵CSNHR
(CR¹R²)ₑNR⁵NHR,
   and when c is greater than 0, W is selected from (CR⁶R⁷)ₑZR, (CH₂)₃SR, (CH₂)₃NRR¹, (CH₂)ₑSR⁸, CH₂CH₂S(CR¹R²)_{f}NR⁵CONHR, CH₂CH₂S(CR¹R²)_{f}NR⁵CSNHR, CH₂CH₂S (CH₂)_{f}OR;
   and wherein when W is (CR⁶R⁷)ₑZR and Z is O or S, X is also selected from
[CH₂CH₂NR¹]ₚR²;
(CR¹R²)_{f}CONHR;
(CR¹R²)_{f}CON[CH₂CH₂NR¹]ₚR;
   and wherein when X is H, c is always greater than 0 and W is selected from
(CH₂)₃SR;
(CH₂)₃NRR¹
(CH₂)ₑSR⁸;
CH₂CH₂S(CR¹R²)_{f}NR⁵CONHR
CH₂CH₂S(CR¹R²)_{f}NR⁵CSNHR
CH₂CH₂S(CH₂)_{f}CONHR
CH₂CH₂S(CH₂)_{f}CONHR⁸
CH₂CH₂S(CH₂)_{f}OR;

R, R¹, R², R³, R⁴, R⁵, R⁶ and R⁷ are independently selected from hydrogen, C₁₋₂₂-alkyl group, C₁₋₂₂-aryl group and a C₁₋₂₂-alkylaryl group; R⁸ is selected from [CH₂CH₂NR¹]ₚR² and (CR¹R²)ₘ SR⁹ where R⁹ is hydrogen, C₁₋₂₂-alkyl group, C₁₋₂₂-aryl group, a C₁₋₂₂-alkylaryl group or (CR¹R²)ₑSi(O_{3/2}); e is an integer from 2 to 100; f is an integer from 1 to 100; m is an integer from 2 to 100; p is an integer from 1 to 100;

V is a group which is optionally substituted and selected from a C₁₋₂₂-alkyl group, C₂₋₂₂-alkenyl group, a C₂₋₂₂-alkynyl group, an aryl group a C₁₋₂₂-alkylaryl sulphide group, a sulfoxide, a sulfone, an amine, a polyalkyl amine, a phosphine and other phosphorous containing group; the free valences of the silicate oxygen atoms are saturated by one or more of:

a silicon atom of other groups of Formula 1, hydrogen, a linear or branched C₁₋₂₂-alkyl group, an end group R³₃M¹O_{1/2}, a cross-linking bridge member or by a chain R³_{q}M¹(OR⁴)_{g}O_{k/2} or Al(OR⁴)₃₋ₕO_{h/2} or R³Al(OR⁴)₂₋ᵣO_{r/2};

wherein

M¹ is Si or Ti;

R³ and R⁴ are independently selected from a linear or branched C₁₋₂₂ alkyl group, an aryl group and a C₁₋₂₂-alkylaryl group;

k is an integer from 1 to 3, q is an integer from 1 to 2 and g is an integer from 0 to 2 such that g+k+q=4;

h is an integer from 1 to 3; and

r is an integer from 1 to 2;

or an oxo metal bridging systems where the metal is zirconium, boron, magnesium, iron, nickel or a lanthanide;

a, b, c and d are integers such that the ratio of a:b is from 0.00001 to 100000 and a and b are always greater than 0 and when c is greater than 0 the ratio of c to a+b is from 0.00001 to 100000 and when d is greater than 0 the ratio of d to a+b is from 0.00001 to 100000.

Where an end group and/or cross linker and/or polymer chain is used, it is preferred that the ratio of end group, cross linker or polymer chains to a+b+c+d is from 0 to 999:1 preferably 0.001 to 999:1 and especially 0.01 to 99:1, especially 0.1 to 9:1.

Ratios are molar unless otherwise stated herein.

The compounds of the invention are advantageous as they may be tailored for a wide range of uses including as precious metal recovery agents, as scavengers for inorganic and organic compounds, solid phase extraction materials, purification materials, removal and purification of biological compounds including endotoxins, catalysts, catalyst immobilisation supports, bio-molecule immobilisation supports, anti-microbial agents, hydrophilicity modifiers, flame proofing agents, antistatic agents, solid phase synthesis materials and chromatography materials. Ion exchanger materials based on compounds of Formula 1 also possess high intrinsic activity through selecting and designing functional groups for specific applications and that the functional group or groups can be tuned to have either a high or low level of loading according to the requirements of the user. Other advantages include high thermal stability, fixed and rigid structures, good stability to a wide range of chemical conditions, insolubility in organic solvents, high resistance to ageing, easily purified and high reusability. In addition the processes for the preparation of compounds of Formula 1 are very flexible, allowing a wide range of functionalised materials to be made from a small number of common intermediates and also the porosity of the materials can be varied from micro to macro porous and the loading of the functional groups as well as the other substituents, V and W, in the fragments C and D can be varied as needed. Compounds of Formula 1 have the added advantage of their respective functional groups being firmly attached to a very stable and inert medium. Furthermore compounds of Formula 1 have the added advantages of a very high affinity for both cations and anions coupled with fast kinetics thus enabling very rapid removal of toxic compounds or impurities to very low levels. In addition compounds of Formula 1 can be used as heterogeneous catalysts to conduct a number of chemical transformations and posses the key advantages of being easily separated from the reaction mixture by filtration and also of being recycled and reused.

The optionally substituted linear or branched group selected from C₁₋₂₂-alkyl, C₂₋₂₂-alkenyl, C₂₋₂₂-alkynyl group, an aryl and C₁₋₂₂-alkylaryl group, R¹⁻⁶ groups may independently be linear or branched and/or may be substituted with one or more substituents but preferably contain only hydrogen and carbon atoms. If a substituent is present, it may be selected from nitro, chloro, fluoro, bromo, nitrile, hydroxyl, carboxylic acid carboxylic esters, sulfides, sulfoxides, sulfones, C₁₋₆-alkoxy, a C₁₋₂₂-alkyl or aryl di substituted phosphine, amino, amino C₁₋₂₂-alkyl or amino di (C₁₋₂₂-alkyl) or C₁₋₂₂-alkyl phosphinic or phosphonic group.

Preferably, the optionally substituted linear or branched group selected from C₁₋₂₂-alkyl, C₂₋₂₂-alkenyl, C₂₋₂₂-alkynyl group, an aryl and C₁₋₂₂-alkylaryl group, R^{1-7, 9} are independently selected from linear or branched C₁₋₂₂ and desirably C₁₋₁₂-alkyl, C₂₋₂₂- and desirably C₂₋₁₂-alkenyl, aryl and a C₁₋₂₂-alkylaryl group and it is especially preferred that these groups are independently selected from a linear or branched C₁₋₈-alkyl, C₂₋₈-alkenyl, aryl and a C₁₋₈-alkylaryl group.

Suitably groups R^{1-7, 9} are independently a C₁₋₆-alkyl group for example methyl or ethyl, or a phenyl group. Preferably q is from 0 to 2, k is from 1 to 3 and g is 0 provided that g+k+q=4.

Examples of suitable alkyl groups include methyl, ethyl, isopropyl, n-propyl, butyl, tert-butyl, n-hexyl, n-decyl, n-dodecyl, cyclohexyl, octyl, iso-octyl, hexadecyl, octadecyl, iso-octadecyl and docosyl. Examples of suitable alkenyl groups include ethenyl, 2-propenyl, cyclohexenyl, octenyl, iso-octenyl, hexadecenyl, octadecenyl, iso-octadecenyl and docosenyl.

C₁₋₆-alkoxy refers to a straight or branched hydrocarbon chain having from one to six carbon atoms and attached to an oxygen atom. Examples include methoxy, ethoxy, propoxy, tert-butoxy and n-butoxy.

The term aryl refers to a five or six membered cyclic, 8-10 membered bicyclic or 10-13 membered tricyclic group with aromatic character and includes systems which contain one or more heteroatoms, for example, N, O or S. Examples of suitable aryl groups include phenyl, pyridinyl and furanyl. Where the term “alkylaryl” is employed herein, the immediately preceding carbon atom range refers to the alkyl substituent only and does not include any aryl carbon atoms. Examples of suitable alkylaryl groups include benzyl, phenylethyl and pyridylmethyl.

Compounds wherein X is independently selected from (CR¹R²)ₑNR⁵CONHR, (CR¹R²)ₑNR⁵CSNHR or (CR¹R²)ₑNR⁵NHR where R, R¹, R² and R⁵ is independently selected from hydrogen C₁₋₆ alkyl or phenyl and e is 2 to 6 are preferred and when c is greater than 0, W is selected from (CH₂)ₑSR, (CH₂)₃SR, (CH₂)₃NRR¹, (CH₂)ₑSW, CH₂CH₂S(CH₂)₂NHCONHR, CH₂CH₂S (CH₂)₂NH CS NHR, CH₂CH₂S (CH₂)_{f} OR where f is 2 to 12 and R⁸ is selected from [CH₂CH₂NH]ₚH and (CH₂)ₘSR⁹ where R⁹ is hydrogen or (CH₂)₂Si(O_{3/2}) and p is 1 to 100 and m is 2 to 10 are preferred. Especially preferred compounds include those in which X is selected from (CR¹R²)ₑNR⁵CONHR and (CR¹R²)ₑNR⁵CSNHR, R¹, R² are hydrogen and e is 2. Suitably R and R⁵ are H or C₁₋₆ alkyl. Where X is H, W is preferably (CH₂)₃SR where R is H or C₁₋₆ alkyl and especially H.

Compounds in which X is hydrogen and c is greater than 0, W is selected from (CH₂)ₑSR, (CH₂)₃SR, (CH₂)₃NRR¹, (CH₂)ₑSR⁸, CH₂CH₂S(CH₂)₂NHCONHR, CH₂CH₂S(CH₂)₂NHCS NHR, CH₂CH₂S(CH₂)_{f}OR where f is 2 to 12, where R and R¹ is independently selected from hydrogen C₁₋₆ alkyl or phenyl and e is 2 to 6 and R⁸ is selected from [CH₂CH₂NH]ₚH and (CH₂)ₘSR⁹ where R⁹ is hydrogen or (CH₂)₂Si(O_{3/2}) and p is 1 to 100 and m is 2 to 10 are preferred.

Compounds in which W is (CH₂)₂ZR and Z is CH₂, O or S, X is selected from [CH₂CH₂NH]ₚH, (CH₂)_{f}CONHR or (CH₂)_{f}CON[CH₂CH₂NH]ₚH where R is independently selected from C₁₋₂₀ alkyl or aryl, p is 1 to 100 and f is 1 to 10 are preferred.

The invention also provides novel precursor compounds for Formula 1, the precursor being of Formula 2 (R⁴O)₃SiCH₂CH₂SX where X is (CR¹R²)ₑNR⁵CONHR, (CR¹R²)ₑNR⁵CSNHR, (CH₂CH₂NR¹)ₚR and (CR¹R²)ₑNR⁵NHR where R, R¹, R², R⁴, R⁵ and the integer e as already defined. Particularly preferred when R¹, R² and R⁵ are hydrogen, R is C₁₋₆ alkyl or phenyl and e is equal to 2 and the integer p is equal to 1 to 20.

The invention also provides a process of producing the precursor of formula (R⁴O)₃SiCH₂CH₂SX comprising reacting a compound of formula (R⁴O)₃SiCH═CH₂ with a thiol of formula HS—X where X is as herein defined. The invention also provides a process for producing trialkoxy compounds of formula (R⁴O)₃SiCH₂CH₂SCR¹R²CR⁵R⁶NRR⁷ by reacting an amine first with optionally substituted ethylene sulfide and then with a compound of formula (R⁴O)₃SiCH═CH₂. The process is suitably carried out in a single reaction step or so called “one pot” process.

The preparation of compounds of Formula 1 will now be discussed in greater detail. The general procedure used for the production of the compounds of Formula 1 comprises first forming the compounds (R⁴O)₃SiCH₂CH₂SX and depending on the reagents and then combining with tetraalkyl orthosilicate and with other compounds such as (R⁴O)₃SiV and (R⁴O)₃SiW, titanium alkoxides, aluminium trialkoxides and alkyl alkoxy silanes, in the desired ratios, in solvent with either dilute acid or base. Alternatively the surfaces of materials such as but not limited to silica, aluminium oxide or carbon can be treated with (R⁴O)₃SiCH₂CH₂SX and if necessary with other compounds such as (R⁴O)₃SiW and (R⁴O)₃SiV, titanium alkoxides, aluminium trialkoxides and alkyl alkoxy silanes to give compounds of Formula 1. These materials can then be subsequently transformed using known chemistry.

There is a lack of simple and effective synthetic methodology for the preparation of functionalised organic or inorganic polymers or materials. This presents a major technical problem to which presently there is no adequate solution. A need exists to provide a solution to this problem given the relationship between chemical structure and performance and the need to utilise the optimum chemical functionality to achieve the desired application. For example there is a lack of simple and effective synthetic methodology for the preparation of readily transformed carbonyl, carboxy, mercapto or hydroxy functionalised organic or inorganic polymers or materials. As a consequence there is a lack of readily available functionalised materials that possess the chemical functionality necessary to remove metal ions held in tightly bound complexes. Given the advantages of inorganic materials such as high thermal stability, fast kinetics and greater solvent compatibility there is a particular need for new simple synthetic methodologies for the preparation of functionalised inorganic materials. In addition the performance of catalysts and immobilised enzymes can be influenced by the nature of the local environment.

An important desired property of functionalised materials is to be able to transform the functional group, attached to the surface via a stable bond, into different groups using known chemistry. These new functionalised materials can then be used for other applications or to optimise existing applications. A further advantage is that a wide range of different functionalised materials can be made from a limited number of intermediates. However a number of problems are encountered in the chemical transformation of surface attached functional groups. For example very long reaction times are often needed to conduct such chemical transformations of surface attached functional groups. These prolonged reaction conditions often result in the functional group being removed from the surface. In addition those reactions that do proceed very often do not go to completion leading to a mixture of products that cannot be separated. To circumvent these difficulties the inventors designed these new functionalised materials with specific additional functionality to enhance the chemical reactivity of these materials. In addition the inventors believed that this design would enhance the properties of the materials for a number of desired applications.

Compounds such as (R⁴O)₃SiCH₂CH₂SX were synthesised via a free radical promoted addition of a thiol HSX to vinyl trialkoxy silane. R⁴ is a linear or branched C₁₋₂₂-alkyl, C₂₋₂₂-alkenyl or C₂₋₂₂-alkynyl group, aryl or C₁₋₂₂-alkylaryl group. A wide range of free radical initiators can be used for this reaction and preferred are the peroxides and in particular the alkyl peroxides. Addition of a very small amount of the initiator every few hours improves the overall yield. Reaction temperatures between 20-170° C. can be used, though a reaction temperature of between 20-120° C. is preferred. Di-tert-butyl peroxide is the preferred free radical initiator. Reaction times of between 5 minutes to 48 hours have been used with ½ to 2 hours preferred.

Known sol-gel technology was one method used to produce the organopolysiloxanes of Formula 1. The state of the arts of sol-gel technology and the hydrolysis of silicon esters are described by M. A. Brook in Silicon in Organic, Organometallic and Polymer Chemistry Chapter 10, page 318, John Wiley & Sons, Inc., 2000, G. A. Scherer in Sol-gel science: the physics and chemistry of sol-gel processing, Boston: Academic Press, 1990, and J. D. Wright in Sol-gel materials: chemistry and applications, Amsterdam: Gordon & Breach Science Publishers, 2001 and the references contained within. Acids and bases were used to catalyse the hydrolysis of the silicon esters of (R⁴O)₃SiCH₂CH₂SX and if necessary with other compounds such as (R⁴O)₃SiW and (R⁴O)₃SiV, and tetraalkyl orthosilicate to produce the organopolysiloxanes of Formula 1.

Templates to aid the preparation of pores with particular sizes and distributions in compounds of Formula 1 can be added at the sol gel stage. On preparation of the solid organopolysiloxane of Formula 1 these templates can be washed out using known methods.

In addition to the groups A, B, C and D, end groups, cross-linking bridge members or polymer chains such as (R³)₃SiO_{1/2} or R³SiO_{3/2} or (R³)₂SiO_{2/2} or TiO_{4/2} or R³TiO_{3/2} or (R³)₂TiO_{2/2} or AlO_{3/2} or R³AlO_{2/2}, where R³ is as defined above, but is preferably methyl or ethyl, or other oxo metals can be added in varying ratios to produce the desired compound of Formula 1. These end groups, cross linking bridge or polymer chain precursors are added at the same time as compounds (R⁴O)₃SiCH₂CH₂SX and tetraalkyl orthosilicate and (R⁴O)₃SiV and (R⁴O)₃SiW.

Compounds of Formula 1 can also be prepared by treating a preformed material such as but not limited to silica, or aluminium oxide or other oxides or carbon with (R⁴O)₃SiCH₂CH₂SX and with (R⁴O)₃SiV and (R⁴O)₃SiW if required, and with other end groups, cross linkers or polymers chains if required, in varying ratios in a solvent. At the end of the reaction the solid is filtered off and washed extensively with solvents such as water or alcohols to remove any remaining starting materials.

Compounds of Formula 1 may be linked to a metal complex, for example as a ligand. A further aspect of the invention provides a Compound of Formula 1 further comprising a metal complex M(L)ⱼ where M is derived from a lanthanide, actinide, main group or transition metal with oxidation states ranging from zero to four and L is one or more optionally substituted ligands selected from halide, nitrate, acetate, carboxylate, cyanide, sulfate, carbonyl, imine, alkoxy, triaryl or trialkylphosphine and phenoxy and j is an integer from 0 to 8 and where the compound of Formula 1 is linked to the said metal complex.

Suitably, M is derived from cobalt, manganese, iron, nickel, palladium, platinum, rhodium, with oxidation states ranging from zero to four and L is one or more optionally substituted ligands selected from halide, nitrate, acetate, carboxylate, cyanide, sulfate, carbonyl, imine, alkoxy, triaryl or trialkylphosphine and phenoxy and j is an integer from 0 to 4.

Compounds of Formula 1 have a wide range of uses. The present invention provides a process for treating a feed material comprising, contacting a compound of Formula 1 with a feed material:

i) to effect a chemical reaction by catalytic transformation of a component of the feed material to produce a desired product;

ii) to remove a component of the feed material so as to produce a material depleted in the removed component; or

iii) to remove an ionic species in the feed material in an ion exchange process.

The feed material may be a continuous stream for example a continuous process reaction feedstock, or may be in the form of a batch of material for discrete treatment. The feed material, for example a waste water or a waste process stream, may be treated to selectively remove a components of the feed. The removed component may be an undesirable material in the feed and the process acts to provide a desired composition for the feed material that has been depleted in the selectively removed component after contact with compounds of Formula 1. This process may be used for example in removing unwanted species from a feed material in a pharmaceutical manufacturing or formulation process to improve the purity level of the pharmaceutical product as regards the removed material, for example metal species.

The process may be employed to remove desired species from a feed material for subsequent processing or analysis, for example a biological molecule such as an enzyme, peptide, protein, endotoxin and nucleic acid may be removed from a feed material to enable further processing or analysis of the removed components

As a consequence of stricter environmental regulations there is a growing requirement for more effective systems for the removal and recovery of cations and anions from a wide spectrum of contaminated solvents, aqueous based wastes and from contaminated waters and contaminated products and pharmaceuticals. Compounds of Formula 1 are very effective at abstracting a wide range of cations and anions from various environments. For cations these include the lanthanides, actinides, main group and transition metals. Anions include arsenates, borates, chromates, permanganates and perchlorates.

Compounds of Formula 1 were designed to have very high affinity for ions and thus be able to remove them from various environments. Such high affinity is required when metal ions are tightly bound to particular functional groups for example in highly polar active pharmaceutical ingredients. The design of compounds of Formula 1 for these applications involves the presence of two or more different ligands to bind strongly to the ion. Depending on the ion to be removed the ligands are designed to be either soft or hard or a combination of both in order to optimise the affinity of the functionalised material for the ion. Furthermore the compounds of Formula 1 have been designed with easily modified functional groups in order to simply find the optimum combination of ligands for specific ion impurities.

For example the products from Examples 1-4 and 14 herein are very effective for the removal of cupric (II) ions from various solutions. Ferrous and ferric ions present in hydro-processing streams are readily removed using the products from Examples 4 and 11 herein. References to the products from Examples are references to the Examples herein.

Compounds of Formula 1 can also remove precious metals such as palladium, platinum and rhodium ion as well as nickel (O) and nickel (II) from various different solutions and also bound to functional groups commonly found in active pharmaceutical ingredients such as amides, amines and carboxylic acids. For example treatment of a palladium acetate solution in tetrahydrofuran or dichloromethane with any of the products from Examples 1-4, 9-11, 14, 16-20 and 27-28 results in the complete removal of the palladium ions from solution. For solutions containing bis(triphenylphosphine) palladium chloride or acetate, the products from Examples 1-4, 16-20 and 27-28 are equally effective for its removal. The products from Examples 1-3, 11, 14, 16-20 are effective for the removal of chlorotris(triphenylphosphine) rhodium(I) from various solutions. The products from Examples 1-3, 9, and 16-20 and 27-28 are effective for the removal of platinum chloride from various solutions. Rhodium (III) is readily removed from various solutions using any of the products from Examples 1-4 and 16-20.

There is a growing use of ruthenium catalysts in the manufacture of complex compounds for a variety of applications. A significant problem encountered with these toxic catalysts is that the metal is bound to the desired compound and can't be readily removed using standard methodologies. Compounds of Formula 1 can also remove ruthenium from various different solutions and also bound to functional groups commonly found in active pharmaceutical ingredients such as amides, amines and carboxylic acids. For example treatment of a ruthenium chloride solution with any of the products from Examples 1-4, 8-9, 16-18 and 27-28 results in the complete removal of the ruthenium ions from solution.

Given their respective catalytic cycles the precious metals are often present in waste steams, solutions or bound to products in more than one oxidation state. Compounds of Formula 1, such as Examples 1-4 and 16-20 can scavenge these precious metals in their different oxidation states.

Compounds of Formula 1 can be used to remove anions such as arsenates, chromates, permanganates, borates and perchlorates. These anions pose many significant problems to the environment and health.

Compounds of Formula 1 can be used, as scavengers, to remove excess inorganic or organic reagents and side products from reactions mixtures or from impure chemical products. In these applications impurities are removed by matching functionality contained in these impurities with specific functionalised materials. For example the amines and polyamine materials prepared in Example 8-10 and 14 respectively can readily remove carboxylic acids and mineral acids as well as other acidic reagents from reaction mixtures. The amines and polyamines prepared in Examples 8-10 and 14-15 respectively can remove isocyanates, acid chlorides, aldehydes, sulfonyl halides and chloroformates. The following examples illustrate the scavenging of unwanted organic and inorganic compounds by compounds of Formula 1 but are not intended to limit the scope of their capability. Toluene sulfonyl chloride, benzoyl chloride and phenyl isocyanate are readily removed using the amides from Examples 8-10 and 14-15.

Genotoxic agents are capable of causing direct or indirect damage to DNA. One class of genotoxic impurities are known alkylating agents such alkyl halides and sulfonyl esters and halides. As illustrated in Examples 24 to 26 the thiourea's of Formula 1 are very effective at removing compounds containing such functional groups.

Compounds of Formula 1 can also be used for solid phase synthesis through first attachment of the starting material. A number of chemical reactions can then be conducted and in each step purification is facile through simple filtration. At the end of the sequence the desired material is released from the solid phase.

In addition compounds of Formula 1 can be used as materials for solid phase extraction where a desired product is purified through selective retention on the functionalised materials whilst the impurities are removed. The desired material is then subsequently released using a different solvent system.

Further applications of compounds of Formula 1 include the use as materials for chromatographic separations.

Compounds of Formula 1, containing optically active groups can be used as materials for chiral separation.

Compounds of Formula 1 can be used as materials for gel filtration and high speed size-exclusion chromatography as well as for high pressure liquid chromatography and solid phase extraction.

Compounds of Formula 1 can be used both to immobilise biological molecules such as enzymes, polypeptides, proteins and nucleic acids as well as for their separation and purification. Immobilised enzymes possess many operational and performance advantages. Examples of enzymes that can be immobilised to compounds of Formula 1 include but not limited to lipases, esterases, hydrolases, transferases, oxidoreductases and ligases.

A known disadvantage of immobilised enzymes is that performance is diminished or lost completely on attachment to a support. Further disadvantages include leaching of the enzyme from the support leading to loss of activity of the immobilised enzyme along with impure products.

Known methods were used to attach the enzyme to the functionality on the surface of compounds of Formula 1. This includes but not limited to the use of a dialdehyde such as glutaraldehyde, di-isothiocyanate and a di-isocyanate. Using glutaraldehyde an imine is formed though attachment to the surface via an amine and likewise via an amino group on the enzyme. Coupling of an enzyme to an amino group attached to a surface can also be achieved using a water soluble carbodiimide such as EDC 1-Ethyl-3-[3-dimethylaminopropyl] carbodiimide hydrochloride. Another coupling approach involves the use of cyanogen halides. Other chemical methods such as di-imide chemistry can also be used to immobilise the enzyme to the functional groups on the surface. In all such cases the enzyme is covalently attached to the inorganic support. This is particularly advantageous as the immobilised enzyme can be removed and reused as well as facilitating product purification. Another operational advantage is that the immobilised enzymes can be used as a fixed bed and in flow chemistry.

In a flow experiment high enantioselective hydrolysis was achieved by passing an aqueous organic solution containing a racemic ester through a column of an immobilised lipase, Thermomyces Lanuginosa containing either Example 41 or 42, over a period of twenty hours. No enzymatic activity was lost over six additional uses of the immobilised enzyme demonstrating no leaching of the enzyme from the support. In an identical experiment the same lipase physically adsorbed onto a support using alternative technology did not retain activity through leaching from the support.

It is reported that dissolved lipases such as Thermomyces Lanuginosa prefer to be in a lipophilic environment in order to retain enzymatic activity. In Examples 21, 22, 37-43 the environment around the immobilised enzyme was made lipophilic by the attachment of alkyl and alkenyl groups along with the functionality to attach the enzyme. Optionally substituted alkylaryl, alkenyl, alkenylaryl and aryl groups as well as hetero substituted alkyl groups can be similarly attached, to create the lipophilic environment, along with the functionality for enzyme immobilisation.

In the hydrolysis of p-nitrophenylbutyrate using the method described by Sang H. L. et al. Journal Molecular Catalysis, 47, 2007, 129-134 all the Lipase modified silica (Examples 37-42) displayed high enzymatic activity with comparable activity to the homogeneous enzyme. Thus enzymatic activity was maintained on immobilisation.

The activity of these lipophilic modified immobilised enzymes is believed to depend on the combination of the enzyme and the structural nature of the lipophilic group. Thus depending on this combination enzymatic activity can be enhanced through the additional surface modification. In the hydrolysis of p-nitrophenylbutyrate the lipase immobilised enzymes in Examples 37, 39 and 41 demonstrated higher enzymatic activity compared to Examples 38 and 40 where the lipophilic group is smaller or more polar in nature.

In addition nucleic acids immobilised on compounds of Formula 1 can be used for conducting high volume nucleic acid hybridization assays.

Endotoxins are lipopolysaccharides, an integral part of cell wall of gram-negative bacteria, e.g. E. coli. Endotoxins cause pyrogenic and shock reactions in mammals and in addition are pervasive and difficult to remove from products, mixtures and aqueous streams. They are highly active at very low concentrations and existing methods of removal such as membrane technology are not very effective. Compounds of Formula 1 such as those made in Examples 8, 9, 10 and 14 can remove endotoxins from aqueous environments.

Compounds of Formula 1 can be used as anti-microbial agents. The invention also provides an antimicrobial composition comprising a compound of Formula 1 and a carrier.

Compounds of Formula 1 can be applied as thin films onto a variety of surfaces.

The invention will now be described in detail with reference to illustrative examples of the invention.

### EXAMPLE 1

A mixture containing 2-aminoethyl hydrochloride 2′-trimethoxysilylethyl sulfide (1.54 moles) and silica (1 kg) in toluene (2.5 L) was refluxed with stirring for 4 hours. The mixture was cooled to room temperature and then filtered. The solid was washed with toluene (1 L), methanol (1 L), aqueous base (2×2 L), deionised water (2 L) and methanol (2 L) and then dried under reduced pressure to give the immobilised amino sulfide (1.1 kg). A mixture of the amino sulfide silica (100 g, 0.1 moles) and methyl isothiocyanate (0.25 moles) in toluene (300 mL) was heated with stirring for 3 hours. On cooling the mixture was filtered and the solid was washed well with water to give a thiourea (105 g) of Formula 1 where c and d are zero, R¹, R² and R⁵ is hydrogen and R is methyl.

### EXAMPLE 2

A mixture containing 2-aminoethyl hydrochloride 2′-trimethoxysilylethyl sulfide (0.154 moles) and silica (100 g) in toluene (250 mL) was refluxed with stirring for 4 hours. The mixture was cooled to room temperature and then filtered. The solid was washed with toluene, methanol, aqueous base, deionised water and methanol and then dried under reduced pressure to give the immobilised amino sulfide (110 g). A mixture of the amino sulfide silica (50 g, 0.05 moles) and ethyl isothiocyanate (0.125 moles) in toluene (150 mL) was heated with stirring for 3 hours. On cooling the mixture was filtered and the solid was washed with water to give a thiourea (55 g) of Formula 1 where c and d are zero, R¹, R² and R⁵ is hydrogen and R is ethyl.

### EXAMPLE 3

A mixture containing 2-aminoethyl hydrochloride 2′-trimethoxysilylethyl sulfide (0.14 moles) and silica (100 g) in toluene (250 mL) was refluxed with stirring for 4 hours. The mixture was cooled down to room temperature and then filtered. The solid was washed with toluene, methanol, aqueous base, deionised water and methanol and then dried under reduced pressure to give the immobilised amino sulfide (110 g). A mixture of the amino sulfide silica (50 g, 0.05 moles) and phenyl isothiocyanate (0.125 moles) in toluene (150 mL) was heated with stirring for 3 hours. On cooling the mixture was filtered and the solid was washed well with water to give a thiourea of Formula 1 where c and d are zero, R¹, R² and R⁵ is hydrogen and R is phenyl.

### EXAMPLE 4

A mixture containing 2-aminoethyl hydrochloride 2′-trimethoxysilylethyl sulfide (1.24 moles), phenyl triethoxysilane (0.3 moles) and silica (1 kg) in toluene (2.5 L) was refluxed with stirring for 4 hours. The mixture was cooled to room temperature and then filtered. The solid was washed with toluene (1 L), methanol (1 L), aqueous base (2×2 L), deionised water (2 L) and methanol (2 L) and then dried under reduced pressure to give the immobilised phenyl amino sulfide (1.15 kg). A mixture of the phenyl amino sulfide silica (100 g, 0.1 moles) and methyl isothiocyanate (0.25 moles) in toluene (300 mL) was heated with stirring for 3 hours. On cooling the mixture was filtered and the solid was washed well with water to give a thiourea (105 g) of Formula 1 where c is zero, R¹, R² and R⁵ is hydrogen and R is methyl and V is phenyl.

### EXAMPLE 5

A mixture containing 2-aminoethyl hydrochloride 2′-trimethoxysilylethyl sulfide (0.08 moles), 1-octyl, 2-trimethoxysilylethyl sulfide (0.06 moles), methyl triethoxysilane (0.03 moles) and silica (100 g) in toluene (250 mL) was refluxed with stirring for 4 hours. The mixture was cooled to room temperature and then filtered. The solid was washed with toluene (1 L), methanol (1 L), aqueous base (2×2 L), deionised water (2 L) and methanol (2 L) and then dried under reduced pressure to give the immobilised phenyl amino sulfide (120 g). A mixture of the amino sulfide silica (100 g, 0.1 moles) and methyl isothiocyanate (0.25 moles) in toluene (300 mL) was heated with stirring for 3 hours. On cooling the mixture was filtered and the solid was washed well with water to give a thiourea (105 g) of Formula 1 where R¹, R² and R⁵ is hydrogen and R is methyl, W is 2-octylsulfinylethyl and V is methyl.

### EXAMPLE 6

A mixture containing 2-aminoethyl hydrochloride 2′-trimethoxysilylethyl sulfide (0.08 moles), octyl 2-trimethoxysilylethyl sulfide (0.02 moles) and tetraethyl orthosilicate (62.4 g, 0.3 mol) was dissolved in methanol (200 mL) and 1 M HCl (36 mL) was added with stirring. The mixture was then warmed at 80° C. until the methanol had evaporated and a glass had formed.

The glass was crushed, washed with aqueous base and then stirred in refluxing methanol. The material was then dried under reduced pressure of 0.1 mm Hg at 80° C. for 2 h to give an amine of Formula 1, where e is 2, R¹ and R² is hydrogen, Z is sulfur, R is octyl, X is 2-aminoethyl and d=0, as a white powder.

### EXAMPLE 7

A mixture containing methyl 2-trimethoxysilylethyl sulfinyl acetate (0.08 moles), 1-octyl 2-trimethoxysilylethyl sulfide (0.08 moles) and silica (100 g) in toluene (250 mL) was refluxed with stirring for 4 hours. The mixture was cooled to room temperature and then filtered. The solid was washed with toluene (1 L) and methanol (1 L) and then dried under reduced pressure to give the immobilised methyl ester (120 g) of Formula 1 where R¹, R² is hydrogen and R is methyl and W is 2-octylsulfinylethyl.

### EXAMPLE 8

A mixture containing methyl 2-trimethoxysilylethyl sulfinyl acetate (0.08 moles), 1-octyl 2-trimethoxysilylethyl sulfide (0.08 moles) and silica (100 g) in toluene (250 mL) was refluxed with stirring for 4 hours. Tetraethylene pentamine (0.107 moles) was added and the mixture was refluxed for a further 3 hours. The mixture was cooled to room temperature and then filtered. The solid was washed with toluene (1 L) and methanol (1 L) and then dried under reduced pressure to give the immobilised amine (122 g) of Formula 1 where R¹, R² is hydrogen and R is the polyamine fragment and W is 2-octylsulfinylethyl.

### EXAMPLE 9

A mixture containing methyl 2-trimethoxysilylethyl sulfinyl acetate (0.06 moles), 1-octyl 2-trimethoxysilylethyl sulfide (0.1 moles) and silica (100 g) in methanol (250 mL) was refluxed with stirring for 4 hours. A polyamine (Mₙ 1300, 0.06 moles) was added and the mixture was refluxed for a further 3 hours. The mixture was cooled to room temperature and then filtered. The solid was washed with toluene (1 L) and methanol (1 L) and then dried under reduced pressure to give the immobilised amine (122 g) of Formula 1 where R¹, R² is hydrogen and R is the polyamine fragment and W is 2-octylsulfinylethyl.

### EXAMPLE 10

A mixture containing methyl 2-trimethoxysilylethyl sulfinyl acetate (0.05 moles), 1-octyl 2-trimethoxysilylethyl sulfide (0.11 moles) and silica (100 g) in methanol (250 mL) was refluxed with stirring for 4 hours. A polyamine (Mₙ 2000, 0.05 moles) was added and the mixture was refluxed for a further 3 hours. The mixture was cooled to room temperature and then filtered. The solid was washed with toluene (1 L) and methanol (1 L) and then dried under reduced pressure to give the immobilised amine (121 g) of Formula 1 where R¹, R² is hydrogen and R is the polyamine fragment and W is 2-octylsulfinylethyl.

### EXAMPLE 11

A mixture containing 2-aminoethyl hydrochloride 2′-trimethoxysilylethyl sulfide (0.08 moles), methyl trimethoxy silane (0.02 moles), dimethyl dimethoxy silane (0.01 moles) and tetraethyl orthosilicate (0.8 mol) was dissolved in methanol (300 mL) and 1 M HCl (36 mL) was added with stirring. The mixture was then warmed at 80° C. until the methanol had evaporated and a glass had formed. The glass was crushed, washed with aqueous base and then stirred in refluxing methanol. The material was then dried under reduced pressure of 0.1 mm Hg at 80° C. for 2 h. A mixture containing this amine material (10 grams) ethyl isocyanate (0.03 moles) in toluene (40 mL) was refluxed with stirring for 4 h and then filtered. The material was washed with water and methanol and then dried under reduced pressure to give an urea of Formula 1, where e is 2, R¹, R²and R⁵ is hydrogen, V is methyl, R is ethyl and c=0, as a white powder.

### EXAMPLE 12

A mixture of diethylene triamine (72.4 mL, 670 mmol) and toluene (150 mL) was heated at 100° C. and then a solution of ethylene sulfide (20 mL, 335 mmol) in toluene (50 mL) was added dropwise over 30 minutes. After 16 h the reaction mixture was cooled and filtered. The filtered solution was evaporated and vinyl trimethoxy silane (34 mL, 224 mmol) and di-tert butyl peroxide (1 mL) were added, and the reaction mixture was heated at 130° C. for 24 h with regular addition of di-tent butyl peroxide (1 mL) to give a mixture containing 2′-trimethoxysilylethyl sulfide 2′-diethylene triamine ethyl sulfide.

### EXAMPLE 13

A mixture of methyl hydrazine (670 mmol) and toluene (150 mL) was heated at 100° C. and then a solution of ethylene sulfide (20 mL, 335 mmol) in toluene (50 mL) was added dropwise over 30 minutes. After 16 h the reaction mixture was cooled and filtered. The filtered solution was evaporated and vinyl trimethoxy silane (34 mL, 224 mmol) and di-tert butyl peroxide (1 mL) were added, and the reaction mixture was heated at 130° C. for 24 h with regular addition of di-tert butyl peroxide (1 mL) to give a mixture containing 2′-trimethoxysilylethyl sulfide 2′-methylhydrazyl ethyl sulfide.

### EXAMPLE 14

A mixture containing 2′-trimethoxysilylethyl sulfide 2′-diethylene triamine ethyl sulfide (0.10 moles), 1-octyl 2-trimethoxysilylethyl sulfide (0.05 moles) and silica (100 g) in toluene (250 mL) was refluxed with stirring for 4 hours. The mixture was cooled down to room temperature and then filtered. The solid was washed with toluene and methanol and then dried under reduced pressure to give a compound of Formula 1 where d is zero, R⁶, and R⁷ is hydrogen, R is octyl and X is 2′- diethylene triamine ethyl.

### EXAMPLE 15

A mixture containing 2′-trimethoxysilylethyl sulfide 2′-methylhydrazyl ethyl sulfide (0.15 moles) and silica (100 g) in toluene (250 mL) was refluxed with stirring for 4 hours. The mixture was cooled down to room temperature and then filtered. The solid was washed with toluene and methanol and then dried under reduced pressure to give a compound of Formula 1 where c and d is zero and X is 2′- methylhydrazyl ethyl.

### EXAMPLE 16

A mixture containing 2-trimethoxysilyl 1-acetylmercapto ethane (0.12 moles) and 3 mercapto, 1-triethoxysilyl propane (0.05 moles) and silica (100 g) in methanol (200 mL) was refluxed with stirring for 4 hours. Methanolic sodium methoxide (0.17 moles) was added and the mixture was cooled down to room temperature and then filtered. The solid was washed with toluene and methanol and then dried under reduced pressure to give a compound of Formula 1 where d is zero and X is hydrogen and W is 3-mercaptopropyl.

### EXAMPLE 17

A mixture containing 2-trimethoxysilyl 1-acetylmercapto ethane (0.14 moles) and 3 amino 1-triethoxysilyl propane (0.02 moles) and silica (100 g) in methanol (200 mL) was refluxed with stirring for 4 hours. Methanolic sodium methoxide (0.17 moles) was added and the mixture was cooled down to room temperature and then filtered. The solid was washed with toluene and methanol and then dried under reduced pressure to give a compound of Formula 1 where d is zero and X is hydrogen and W is 3-aminopropyl.

### EXAMPLE 18

A mixture containing 2-trimethoxysilyl 1-acetylmercapto ethane (0.12 moles) and 2-aminoethyl hydrochloride 2′-trimethoxysilylethyl sulfide (0.05 moles) and silica (100 g) in methanol (200 mL) was refluxed with stirring for 4 hours. Methanolic sodium methoxide (0.17 moles) was added and the mixture was cooled down to room temperature and then filtered. The solid was washed with toluene, water and methanol and then dried under reduced pressure to give a compound of Formula 1 where d is zero and X is hydrogen and W is 2-aminoethylsulfinylethyl.

### EXAMPLE 19

A mixture containing 2-trimethoxysilyl 1-acetylmercapto ethane (0.12 moles) and 3-mercaptopropyl 2′-trimethoxysilylethyl sulfide (0.05 moles) and silica (100 g) in methanol (200 mL) was refluxed with stirring for 4 hours. Methanolic sodium methoxide (0.17 moles) was added and the mixture was cooled down to room temperature and then filtered. The solid was washed with toluene, water and methanol and then dried under reduced pressure to give a compound of Formula 1 where d is zero and X is hydrogen and e is 2, and R⁸ is a mixture of (CH₂)₃SH and (CH₂)₃S(CH₂)₂Si(O_{3/2}).

### EXAMPLE 20

A mixture containing 2-trimethoxysilyl 1-acetylmercapto ethane (0.12 moles) and 2-mercaptoethyl 2′-trimethoxysilylethyl sulfide (0.04 moles) and silica (100 g) in methanol (200 mL) was refluxed with stirring for 4 hours. Methanolic sodium methoxide (0.17 moles) was added and the mixture was cooled down to room temperature and then filtered. The solid was washed with toluene, water and methanol and then dried under reduced pressure to give a compound of Formula 1 where d is zero and X is hydrogen and e is 2, and R⁸ is a mixture of (CH₂)₂SH and (CH₂)₂S(CH₂)₂Si(O_{3/2}).

### EXAMPLE 21

A mixture containing 2-aminoethyl hydrochloride 2′-trimethoxysilylethyl sulfide (0.08 moles), 1-octyl, 2-trimethoxysilylethyl sulfide (0.06 moles) and silica (100 g) in toluene (250 mL) was refluxed with stirring for 4 hours. The mixture was cooled to room temperature and then filtered. The solid was washed with toluene (1 L), methanol (1 L), aqueous base (2×2 L), deionised water (2 L) and methanol (2 L) and then dried under reduced pressure to give the immobilised amino sulfide (120 g). A mixture of the amino sulfide silica (2 g) and excess glutaraldehyde in toluene was stirred for 24 hours and then filtered. The solid was washed well with methanol and then dried. To this solid was added a Lipase in water and the mixture was stirred overnight and then filtered. The immobilised enzyme was washed well with water. Treatment of an aqueous solution of a nitrophenol ester with the immobilised enzyme at room temperature gave complete hydrolysis after 10 minutes. The immobilised enzyme was filtered from the solution and washed with water. Treatment of a fresh sample of an aqueous solution of a nitrophenol ester with this sample also led to complete hydrolysis after 10 minutes.

### EXAMPLE 22

A mixture of the amino sulfide silica (2 g) from Example 21 and excess phenyl di isothiocyanate in acetonitrile was warmed at 40° C. for 4 hours. The filtered solid was washed well with water and then treated with an aqueous solution of a Lipase at room temperature for 4 hours. The immobilised enzyme was filtered from the reaction mixture and washed well with water. Treatment of an aqueous solution of a nitrophenol ester with the immobilised enzyme at room temperature gave complete hydrolysis after 10 minutes. The immobilised enzyme was filtered from the solution and washed with water. Treatment of a fresh sample of an aqueous solution of a nitrophenol ester with this sample also led to complete hydrolysis after 10 minutes.

### EXAMPLE 23

An aqueous endotoxin solution (500 mL, 5×10² EU/mL) was passed through a short column containing the product from Example 9. Analysis of the eluted solution showed that the endotoxin concentration was now below the detection limit (<0.05 EU/mL). The products from Examples 8, 10 and 14 gave the same level of performance.

### EXAMPLE 24

A solution of 2-chloroacetophenone (50 mg) in anhydrous THF (1.5 mL) was treated with the product from Example 1 (2 equivalents, 0.835 g) and the mixture was heated with stirring for 15 hours at 50° C. The silica scavenger was removed using a nylon membrane 0.2 mm, which was washed with 2 mL of anhydrous THF. The organic layer was dried in vacuum and analysed by LC/MS. Scavenging was measured at >93% removal. The product from Example 15 gave the same level of performance.

### EXAMPLE 25

A solution of 2-chloromethyl pyridine (50 mg) in anhydrous THF (1.5 mL) was treated with the product from Example 1 (2 equivalents, 0.762 g) and the mixture was heated with stirring for 15 hours at 40° C. The silica scavenger was removed using a nylon membrane 0.2 mm, which was washed with 2 mL of anhydrous THF. The organic layer was dried in vacuum and analysed by LC/MS. Scavenging was measured at >98% removal.

### EXAMPLE 26

A solution of 2-Chloro-N,N-diethylacetamide (50 mg) in anhydrous THF (1.5 mL) was treated with the product from Example 1 (2 equivalents, 0.735 g) and the mixture was heated with stirring for 15 hours at 50° C. The silica scavenger was removed using a nylon membrane 0.2 mm, which was washed with 2 mL of anhydrous THF. The organic layer was dried in vacuum and analysed by LC/MS. Scavenging was measured at >99% removal.

### EXAMPLE 27

A solution of methyl isothiocyanate (0.35 moles) and 2-aminoethyl hydrochloride 2′-trimethoxysilylethyl sulfide (0.154 moles) in toluene (50 mL) was refluxed with stirring for 4 hours to give (CH₃O)₃SiCH₂CH₂SCH₂CH₂NHC(=S)NHCH₃. This solution was then added to silica (100 g) in toluene (200 L) and the resultant mixture was refluxed with stirring for 4 hours. The mixture was cooled to room temperature and then filtered. The solid was washed with toluene (1 L), methanol (1 L), aqueous base (2×2 L), deionised water (2 L) and methanol (2 L) and then dried under reduced pressure to give a thiourea (115 g) of Formula 1 where c and d are zero, R¹, R² and R⁵ is hydrogen and R is methyl.

### EXAMPLE 28

A solution of (CH₃O)₃SiCH₂CH₂SCH₂CH₂NHC(=S)NHCH₃ (0.05 moles), 2-trimethoxysilyl 1-acetylmercapto ethane (0.12 moles) and silica (100 g) in methanol (200 mL) was refluxed with stirring for 4 hours. Methanolic sodium methoxide (0.17 moles) was added and the mixture was cooled down to room temperature and then filtered. The solid was washed with toluene, water and methanol and then dried under reduced pressure to give a compound of Formula 1 where d is zero and X is hydrogen and e is 2, and W is CH₂CH₂SCH₂CH₂NHC(=S)NHCH₃.

### EXAMPLE 29

The product from Example 10 (0.06 g) was added to a sample (1 ml) of a 500 ppm dark orange/brown coloured solution of ruthenium trichloride in a mixture of chloroform and dichloromethane. The solution went completely colourless. The mixture was filtered. Analysis of the filtrate showed that the ruthenium had been removed. Examples 1 to 4, 8, 9, 11, 15-20 and 27-28 were equally effective in the above test.

### EXAMPLE 30

The product from Example 1 (0.06 g) was added to a sample (1 ml) of a 150 ppm orange coloured solution of chlorotris(triphenylphosphine)rhodium (Wilkinson's catalyst) in chloroform. The solution went completely colourless. The mixture was then filtered. Analysis of the filtrate showed that the rhodium had been removed. Examples 9-11, 14, 16-20 and 27-28 were equally effective in the above test.

### EXAMPLE 31

The product from Example 1 (0.06 g) was added to a sample (1 ml) of a 160 ppm orange coloured solution of palladium acetate in dichloromethane. The solution went completely colourless. The mixture was then filtered. Analysis of the filtrate showed that the palladium had been removed. Examples 2-4, 16-20, and 27-28 were equally effective in the above test.

### EXAMPLE 32

The product from Example 1 (0.06 g) was added to a sample (1 ml) of a 160 ppm orange coloured solution of tetrakistriphenylphosphine palladium in dichloromethane. The solution went completely colourless. The mixture was then filtered. Analysis of the filtrate showed that the palladium had been removed. Examples 16-20, and 27-28 were equally effective in the above test.

### EXAMPLE 33

The product from Example 11 (0.06 g) was added to a sample (1 ml) of a 1300 ppm light yellow coloured solution of potassium tetrachloro platinate in water. The solution went completely colourless. The mixture was then filtered. Analysis of the filtrate showed that the platinum had been removed. Examples 1 and 16-20, and 27-28 were equally effective in the above test.

### EXAMPLE 34

A mixture containing para toluenesulfonic acid (0.019 g, 0.1 mmol) and the product from Example 10 (0.54 g, 0.10 mmol) in ether (10 ml) was stirred at room temperature for 1 h and then filtered. The filtrate was concentrated and the residue weighted. Greater then 97% of the para toluenesulfonic acid was removed. Examples 8, 9 and 15 were equally effective in the above test.

### EXAMPLE 35

A mixture of anisole (0.031 g, 0.28 mmol), ethyl chloroformate (0.027 g, 0.25 mmol) and the product from Example 10 (0.59 g, 1.11 mmol) was stirred in CDCl₃ (2.5 cm³) at room temperature for 1.5 h. The mixture was then centrifuged and a ¹H NMR spectrum of the chloroform solution showed that the ethyl chloroformate was completely removed. Examples 8, 9, and 15 were equally effective in this test.

### EXAMPLE 36

A mixture of dimethoxyethane (0.022 g, 0.25 mmol), phenyl isocyanate (0.029 g, 0.24 mmol) and the product from Example 1 (0.45 g, 0.97 mmol) was stirred in CDCl₃ (2.5 cm³) at room temperature for 1.5 h. The mixture was then centrifuged and a ¹H NMR spectrum of the chloroform solution showed that the phenyl isocyanate was completely removed. Examples 8-10 and 15 were equally effective in this test.

### EXAMPLE 37

A mixture containing 2-aminoethyl hydrochloride 2′-trimethoxysilylethyl sulfide (0.03 moles), 1-dodecyl, 2-trimethoxysilylethyl sulfide (0.07 moles) and silica (100 g) in toluene was refluxed with stirring for 4 hours. The mixture was cooled to room temperature and then filtered. The solid was washed with toluene, methanol, aqueous base, deionised water and methanol and then dried under reduced pressure to give the immobilized amino sulfide (120 g). A mixture of the amino sulfide silica (2 g) and excess glutaraldehyde in water solution was stirred for 6 or 8 hours and then filtered. The solid was washed well with water and then dried removing the excess of water. To this solid was added a Lipase in water and the mixture was stirred 8 hours and then filtered. The immobilized enzyme was washed well with water. The immobilized enzyme was filtered from the solution and washed with a solution of calcium acetate 1 M in water.

### EXAMPLE 38

A mixture containing 2-aminoethyl hydrochloride 2′-trimethoxysilylethyl sulfide (0.05 moles), vinyltrimethoxysilane sulfide (0.05 moles) and silica (100 g) in toluene (250 mL) was refluxed with stirring for 4 hours. The mixture was cooled to room temperature and then filtered. The solid was washed with toluene, methanol, aqueous base, deionised water and methanol and then dried under reduced pressure to give the immobilized amino sulfide (120 g). A mixture of the amino sulfide silica (2 g) and excess glutaraldehyde in water solution was stirred for 6 or 8 hours and then filtered. The solid was washed well with water and then dried removing the excess of water. To this solid was added a Lipase in water and the mixture was stirred overnight and then filtered. The immobilized enzyme was washed well with water.

### EXAMPLE 39

A mixture containing 2-aminoethyl hydrochloride 2′-trimethoxysilylethyl sulfide (0.05 moles), 1-butyl, 2-trimethoxysilylethyl sulfide (0.05 moles) and silica (100 g) in toluene (250 mL) was refluxed with stirring for 4 hours. The mixture was cooled to room temperature and then filtered. The solid was washed with toluene, methanol, aqueous base, deionised water and methanol and then dried under reduced pressure to give the immobilized amino sulfide (120 g). A mixture of the amino sulfide silica (2 g) and excess glutaraldehyde in water solution was stirred for 6 or 8 hours and then filtered. The solid was washed well with water and then dried removing the excess of water. To this solid was added a Lipase in water and the mixture was stirred overnight and then filtered. The immobilized enzyme was washed well with water. The immobilised enzyme was filtered from the solution and washed with a solution of calcium acetate 1 M in water.

### EXAMPLE 40

A mixture containing 2-aminoethyl hydrochloride 2′-trimethoxysilylethyl sulfide (0.03 moles), 2-(2-mercaptoethoxy)ethoxyethyl ethyl sulphide trimethoxy silane (0.07 moles) and silica (100 g) in toluene (250 mL) was refluxed with stirring for 4 hours. The mixture was cooled to room temperature and then filtered. The solid was washed with toluene, methanol, aqueous base, deionised water and methanol and then dried under reduced pressure to give the immobilized amino sulfide (120 g). A mixture of the amino sulfide silica (2 g) and excess glutaraldehyde in water solution was stirred for 6 or 8 hours and then filtered. The solid was washed well with water and then dried removing the excess of water. To this solid was added a Lipase in water and the mixture was stirred overnight and then filtered. The immobilized enzyme was washed well with water.

### EXAMPLE 41

A mixture containing 2-aminoethyl hydrochloride 2′-trimethoxysilylethyl sulfide (0.03 moles), 1-butyl, 2-trimethoxysilylethyl sulfide (0.07 moles) and silica (100 g) in toluene (250 mL) was refluxed with stirring for 4 hours. The mixture was cooled to room temperature and then filtered. The solid was washed with toluene, methanol, aqueous base, deionised water and methanol and then dried under reduced pressure to give the immobilized amino sulfide (120 g). A mixture of the amino sulfide silica (2 g) and excess glutaraldehyde in water solution was stirred for 6 or 8 hours and then filtered. The solid was washed well with water and then dried removing the excess of water. To this solid was added a Lipase in water and the mixture was stirred overnight and then filtered. The immobilized enzyme was washed well with water.

### EXAMPLE 42

A mixture containing 2-aminoethyl hydrochloride 2′-trimethoxysilylethyl sulfide (0.03 moles), 1-benzyl, 2-trimethoxysilylethyl sulfide (0.07 moles) and silica (100 g) in toluene was refluxed with stirring for 4 hours. The mixture was cooled to room temperature and then filtered. The solid was washed with toluene, methanol, aqueous base, deionised water and methanol and then dried under reduced pressure to give the immobilized amino sulfide (120 g). A mixture of the amino sulfide silica (2 g) and excess glutaraldehyde in water solution was stirred for 6 or 8 hours and then filtered. The solid was washed well with water and then dried removing the excess of water. To this solid was added a Lipase in water and the mixture was stirred 8 hours and then filtered. The immobilized enzyme was washed well with water. The immobilized enzyme was filtered from the solution and washed with a solution of calcium acetate 1 M in water.

### EXAMPLE 43

A mixture containing 2-aminoethyl hydrochloride 2′-trimethoxysilylethyl sulfide (0.03 moles), 1-octadecyl, 2-trimethoxysilylethyl sulfide (0.07 moles) and silica (100 g) in toluene was refluxed with stirring for 4 hours. The mixture was cooled to room temperature and then filtered. The solid was washed with toluene, methanol, aqueous base, deionised water and methanol and then dried under reduced pressure to give the immobilized amino sulfide (120 g). A mixture of the amino sulfide silica (2 g) and excess glutaraldehyde in water solution was stirred for 6 or 8 hours and then filtered. The solid was washed well with water and then dried removing the excess of water. To this solid was added a Lipase in water and the mixture was stirred 8 hours and then filtered. The immobilized enzyme was washed well with water. The immobilized enzyme was filtered from the solution and washed with a solution of calcium acetate 1 M in water.

### EXAMPLE 44

The specific activities (PLU/g) for esterification of materials from Examples 37-41 were determined using a solution of p-nitrophenylbutyrate (Sang H. L. et al. Journal Molecular Catalysis, 47, 2007, 129-134). A sample of lipase modified silica was added to a phosphate buffer followed by a solution of p-nitrophenylbutyrate in DMF at 25° C. with shaking. Periodically, aliquots were taken and analyzed by UV-spectrometer. The specific activity was determined by measuring the increase in absorbance at 400 nm by the p-nitrophenol produced during the hydrolysis of p-nitrophenylbutyrate. The specific activities (PLU/g), after 5 minutes, determined under these conditions are as follows, Example 37 267,000; Example 38 166,000; Example 39 280,000; Example 40 165,000 and Example 41 234,000.

1. A compound of Formula 1:
[(O_{3/2})SiCH₂CH₂SX]ₐ[Si(O_{4/2})]_{b}[WSi(O_{3/2})]_{c}[VSi(O_{3/2})]_{d}
wherein X is selected from
H
(CR¹R²)ₑNR⁵CONHR
(CR¹R²)ₑNR⁵CSNHR
(CR¹R²)ₑNR⁵NHR,
and when c is greater than 0, W is selected from (CR⁶R⁷)ₑZR, (CH₂)₃SR, (CH₂)₃NRR¹, (CH₂)ₑSR⁸, CH₂CH₂S(CR¹R²)_{f}NR⁵CONHR, CH₂CH₂S(CR¹R²)_{f}NR⁵CSNHR, CH₂CH₂S(CH₂)_{f}OR;
and wherein when W is (CR⁶R⁷)ₑZR and Z is O or S, X is also selected from
[CH₂CH₂NR¹]ₚR²;
(CR¹R²)_{f}CONHR;
(CR¹R²)_{f}CON[CH₂CH₂NR¹]ₚR;
and wherein when X is H, c is always greater than 0 and W is selected from
(CH₂)₃SR;
(CH₂)₃NRR¹;
(CH₂)ₑSR⁸;
CH₂CH₂S(CR¹R²)_{f}NR⁵CONHR;
CH₂CH₂S(CR¹R²)_{f}NR⁵CSNHR;
CH₂CH₂S(CH₂)_{f}CONHR
CH₂CH₂S(CH₂)_{f}CONHR⁸
CH₂CH₂S(CH₂)_{f}OR;
R, R¹, R², R³, R⁴, R⁵, R⁶ and R⁷ are independently selected from hydrogen, C₁₋₂₂-alkyl group, C₁₋₂₂-aryl group and a C₁₋₂₂-alkylaryl group; R⁸ is selected from [CH₂CH₂NR¹]ₚR² and (CR¹R²)ₘSR⁹
where R⁹ is hydrogen, C₁₋₂₂-alkyl group, C₁₋₂₂-aryl group, a C₁₋₂₂-alkylaryl group or (CR¹R²)ₑSi(O_{3/2}); e is an integer from 2 to 100; f is an integer from 1 to 100; m is an integer from 2 to 100;
p is an integer from 1 to 100;
V is a group which is optionally substituted and selected from a C₁₋₂₂-alkyl group, C₂₋₂₂-alkenyl group, a C₂₋₂₂-alkynyl group, an aryl group a C₁₋₂₂-alkylaryl sulphide group, a sulfoxide, a sulfone, an amine, a polyalkyl amine, a phosphine and other phosphorous containing group;
the free valences of the silicate oxygen atoms are saturated by one or more of:
a silicon atom of other groups of Formula 1, hydrogen, a linear or branched C₁₋₂₂-alkyl group, an end group R³₃M¹O_{1/2}, a cross-linking bridge member or by a chain R³_{q}M¹(OR⁴)_{g}O_{k/2} or Al(OR⁴)₃₋ₕO_{h/2} or R³Al(OR⁴)₂₋ᵣO_{r/2};
wherein
M¹ is Si or Ti;
R³ and R⁴ are independently selected from a linear or branched C₁₋₂₂ alkyl group, an aryl group and a C₁₋₂₂-alkylaryl group;
k is an integer from 1 to 3, q is an integer from 1 to 2 and g is an integer from 0 to 2 such that g+k+q=4;
h is an integer from 1 to 3; and
r is an integer from 1 to 2;
or an oxo metal bridging systems where the metal is zirconium, boron, magnesium, iron, nickel or a lanthanide;
a, b, c and d are integers such that the ratio of a:b is from 0.00001 to 100000 and a and b are always greater than 0 and when c is greater than 0 the ratio of c to a+b is from 0.00001 to 100000 and when d is greater than 0 the ratio of d to a+b is from 0.00001 to 100000.

2. A compound as claimed in claim 1 which includes an end group and/or cross linking bridge member and/or polymer chain and wherein the ratio of an end group and/or cross linker and/or polymer chain to a+b+c+d varies from 0 to 999:1.

3. A compound as claimed in claim 1 that includes an end group derived from a trialkyl or triaryl alkoxysilane or a cross linking bridge member derived from an orthosilicate, a titanium alkoxide or an aluminium trialkoxide or a polymer chain derived from a mono alkyl or mono aryl trialkoxysilane or a di alkyl or di aryl dialkoxysilane.

4. A compound as claimed in claim 3 wherein the one or more end groups or cross linking bridges or polymer chains are selected from R³₂SiOR⁴O_{1/2}, R³₃SiO_{1/2} or R³₂SiO_{2/2} or TiO_{4/2} or R³TiO_{3/2} or R³₂TiO_{2/2} or AlO_{3/2} or R³AlO_{2/2}, wherein R³ and R⁴ are as defined in claim 1.

5. A compound as claimed in claim 4 wherein R³ is independently selected from linear or branched C₁₋₂₂-alkyl, aryl and a C₁₋₂₂-alkylaryl group.

6. A compound as claimed in claim 5 wherein R³ is C₁₋₆-alkyl, C₂₋₁₂-alkenyl or aryl.

7. A compound as claimed in claim 1 comprising a metal complex M(L)ⱼ where M is derived from a lanthanide, actinide, main group or transition metal with oxidation states ranging from zero to four and L is one or more optionally substituted ligands selected from halide, nitrate, acetate, carboxylate, cyanide, sulfate, carbonyl, imine, alkoxy, triaryl or trialkylphosphine and phenoxy and j is an integer from 0 to 8 and where the compound of Formula 1 is linked to the said metal complex .

8. A compound as claimed in claim 1 comprising a protonated complex or metal complex M(L)ⱼ where M is derived from cobalt, manganese, iron, nickel, palladium, platinum, rhodium, with oxidation states ranging from zero to four and L is one or more optionally substituted ligands selected from halide, nitrate, acetate, carboxylate, cyanide, sulfate, carbonyl, imine, alkoxy, triaryl or trialkylphosphine and phenoxy and j is an integer from 0 to 4 and where the compound of Formula 1 is linked to the said metal complex.

9. A compound as claimed in claim 1 wherein X is independently selected from H, (CR¹R²)ₑNR⁵CONHR, (CR¹R²)ₑNR⁵CSNHR or (CR¹R²)ₑNR⁵NHR where R, R^{1-2, 5} is independently selected from hydrogen, C₁₋₆ alkyl or phenyl and e is 2 to 6; and when c is greater than 0, W is selected from (CH₂)ₑSR, (CH₂)₃SR, (CH₂)₃NRR¹, (CH₂)ₑ SR⁸, CH₂CH₂S (CH₂)₂NH CO NHR, CH₂CH₂S (CH₂)₂NH CS NHR, CH₂CH₂S (CH₂)_{f}OR where f is 2 to 12 and R⁸ is selected from [CH₂CH₂NH]ₚH or (CH₂)ₘSR⁹ where R⁹ is hydrogen or (CH₂)₂Si(O_{3/2}) and p is 1 to 100 and m is 2 to 10.

10. A compound as claimed in claim 1 wherein X is hydrogen and c is greater than 0, W is selected from (CH₂)ₑSR, (CH₂)₃SR, (CH₂)₃NRR¹, (CH₂)ₑSR⁸, CH₂CH₂S(CH₂)₂NHCONHR, CH₂CH₂S(CH₂)₂NHCSNHR, CH₂CH₂S (CH₂)_{f}OR where f is 2 to 12, where R and R¹ is independently selected from hydrogen C₁₋₆ alkyl or phenyl and e is 2 to 6 and R⁸ is selected from [CH₂CH₂NH]ₚH and (CH₂)ₘSR⁹ where R⁹ is hydrogen or (CH₂)₂Si(O_{3/2}) and p is 1 to 100 and m is 2 to 10.

11. A compound as claimed in claim 1 wherein W is (CH₂)₂ZR and Z is CH₂, O or S; and X is selected from [CH₂CH₂NH]ₚH, (CH₂)_{f}CONHR or (CH₂)_{f}CON[CH₂CH₂NH]ₚH where R is independently selected from C₁₋₂₀ alkyl or aryl, p is 1 to 100 and f is 1 to 10.

12. A compound as claimed in claim 9 wherein the free valences of the silicate oxygen atoms are saturated by one or more of silicon atoms of other groups of Formula 1, hydrogen, a linear or branched C₁₋₆ alkyl group or by end groups R³₃SiO_{1/2} or by cross-linking bridge members or by polymer chains R³_{q}SiO_{k/2} where R³ is a linear or branched C₁₋₄ alkyl group; k is an integer from 2 to 3 and q is an integer from 1 to 2; such that k+q=4; and the integers a, b, c and d are such that i) the ratio of a:b is from 0.00001 to 100,000 and in the formula AₐB_{b}C_{c}D_{d} both A and B are always present, and ii) when C is present the ratio of c to a+b varies from 0.00001 to 100,000, iii) when D is present the ratio of d to a+b varies from 0.00001 to 100,000, and the ratio of end groups and/or cross linkers and/or polymer chains to a+b+c+d varies from 0 to 999:1.

13. A compound as claimed in claim 12 wherein a, b and c are such that i) the ratio of a:b is from 0.01 to 100 and in the formula AₐB_{b}C_{c}D_{d} both A and B are always present, and ii) when C is present the ratio of c to a+b varies from 0.01 to 100, and iii) when D is present the ratio of d to a+b varies from 0.01 to 100, and the ratio of end groups and/or cross linkers and/or polymer chains to a+b+c+d varies from 0 to 99:1.

14. A compound of Formula 2: [(R⁴O)₃SiCH₂CH₂SX] wherein X is selected from (CR¹R²)ₑNR⁵CONHR, (CR¹R²)ₑNR⁵CSNHR, (CH₂CH₂NR¹)ₚR and (CR¹R²)ₑNR⁵NHR where R, R¹, R² and R⁵ is independently selected from hydrogen, C₁₋₁₂ alkyl or phenyl, R⁴ is selected from C₁₋₁₂ alkyl or phenyl, p is 1 to 100 and e is 2 to 6.

15. A process for treating a feedstock comprising, contacting a compound of Formula I as claimed in claim 1 with a feed stream:
i) to effect a chemical reaction by catalytic transformation of a component of the feed stream to produce a desired product;
ii) to remove a component of the feed stream from the stream; or
iii) to remove an ionic species in the feed stream in an ion exchange process.

16. (canceled)

17. A process according to claim 32 in which the feed material is a reaction mixture, waste stream or waste water.

18. (canceled)

19. A process according to claim 17 in which the precious metal or ion is one or more of platinum, palladium, rhodium, ruthenium, rhenium gold, or nickel.

20. A process of effecting exchange of a cation or anion comprising contacting a cation or anion containing material with at least one cation or anion-exchanging compound of Formula I as claimed in claim 1.

21-31. (canceled)

32. A process according to claim 15 for treating a feed material comprising at least one precious metal to be removed and at least one further metal, the process comprising contacting the feed material with at least one metal scavenging compound of Formula I to selectively remove one or more of the precious metals from the feed material in the presence of the at least one further metal to produce a feed material depleted in the removed at least one precious metal.
